(19) United States
(12) Patent Application Publication
(10) Pub. No.: US 2026/0208690 A1
(43) Pub. Date: Jul. 23, 2026

(54) IMPROVEMENTS RELATING TO STEERING WHEEL LOCKS

(71) Applicant: THE ACE SUPPLY HOLDING COMPANY LIMITED, Sale, Greater Manchester (GB)

(72) Inventor: Alan SOMERFIELD, Sale, Greater Manchester (GB)

(73) Assignee: THE ACE SUPPLY HOLDING COMPANY LIMITED, Sale, Greater Manchester (GB)

(21) Appl. No.: 19/137,634

(22) PCT Filed: Dec. 13, 2023
(86) PCT No.: PCT/GB2023/053204

§ 371 Date: Jun. 10, 2025

(30) Foreign Application Priority Data
Dec. 14, 2022 (GB) 2218817.1
Mar. 30, 2023 (GB) 2304733.5

(51) Int. Cl. B60R 25/022

(52) U.S. Cl. CPC B60R 25/0225

(57) ABSTRACT

A steering wheel lock device (100) comprising: a fixed part (2); a foldable part (3); a hinge (4) connecting the foldable part (3) to the fixed part (2); a shackle (5) to secure the device (100) to a rim (1a) of a steering wheel (1); and a lock (7) enabling the shackle to be released. The shackle (5) and the hinge (4) are located towards opposite ends of the fixed part (2), and wherein when the device (100) is locked to the steering wheel (1) a rim (1a) of the steering wheel (1) prevents the foldable part (3) from being rotated to a position corresponding to a compact form of the device. Additionally, or alternatively, at least one of the fixed part (2) or the foldable part (3) is curved to fit the steering wheel (1).

This application is a U.S. National Stage Entry of PCT Application No. PCT/GB2023/053204, filed Dec. 13, 2023, which is hereby incorporated by reference in its entirety for all purposes.

There are many devices known in the prior art for attaching to steering wheels of vehicles in such a way as to prevent rotation of the wheel and therefore unauthorised use and theft of the vehicle. This invention is an improvement to the type of steering wheel lock disclosed in U.S. Pat. No. 5,115,652 which is characterized by having only one attachment point to the rim of the steering wheel, whilst the opposing end of the device is threaded through a gap in the steering wheel beneath the opposite rim. Whilst this type of device gives a simple and easy method of attachment to the steering wheel it is large, bulky and awkward to store inside the car when the vehicle is not in use. Additionally because these types of products are heavy and usually made of steel they can become highly dangerous projectiles inside the vehicle in the event of an accident.

The present invention provides a solution to this problem by allowing the device to become more compact and easier to stow inside the car when the vehicle is in use.

A preferred embodiment will now be described with reference to the following figures where;

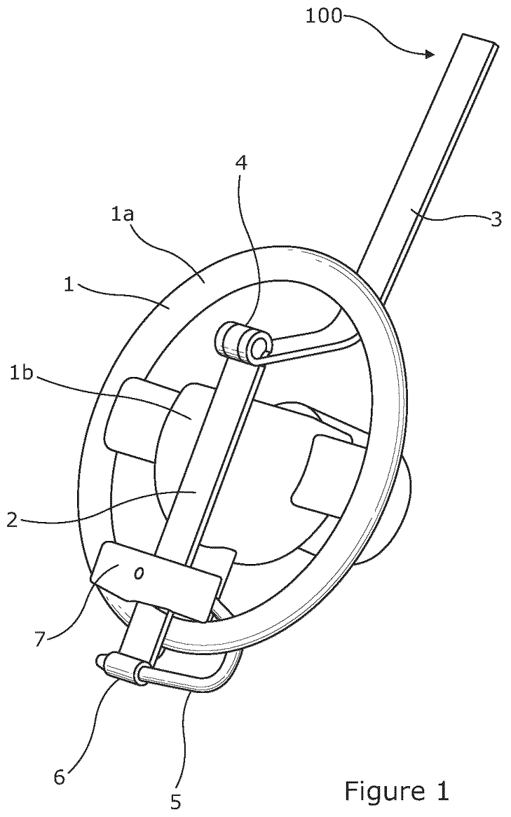

FIG. 1 shows the device locked to a steering wheel;

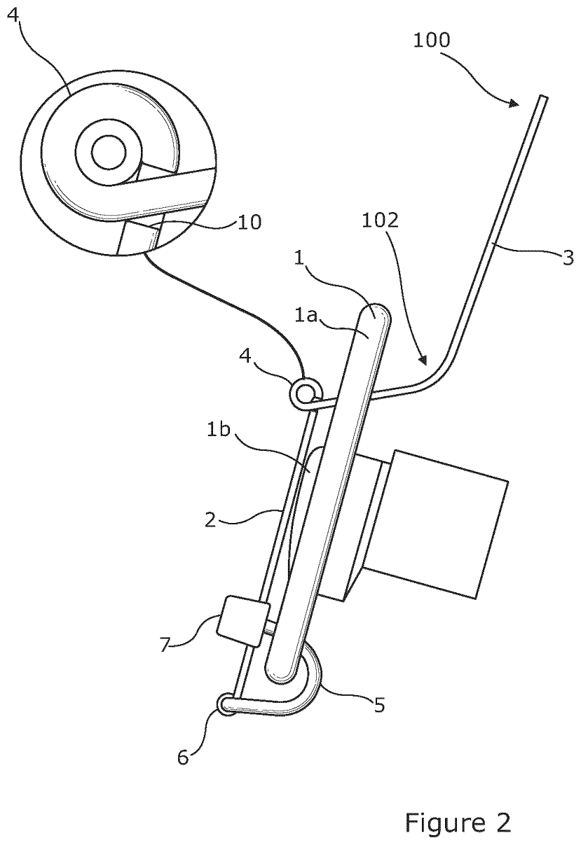

FIG. 2 shows an elevation view of the device locked to a steering wheel;

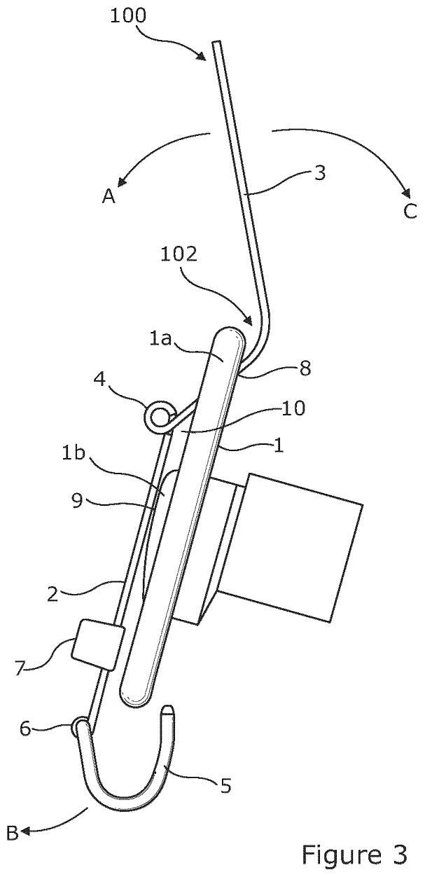

FIG. 3 shows the device being removed from the steering wheel;

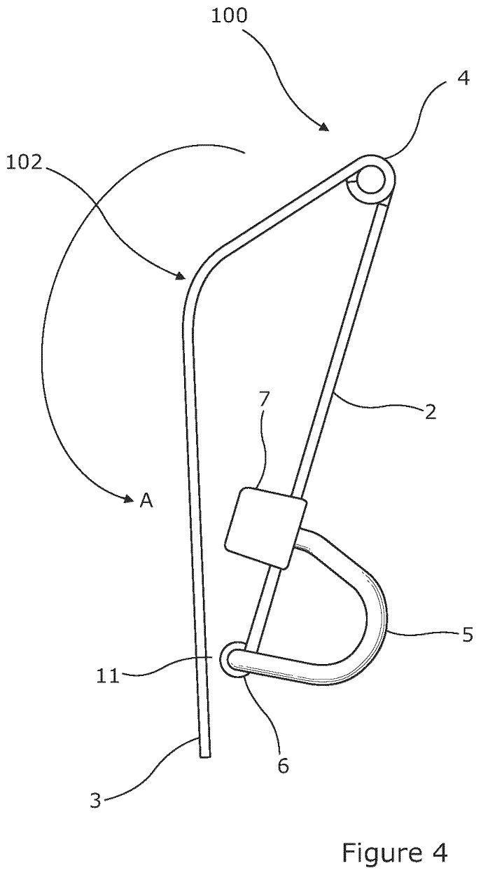

FIG. 4 shows the device in the stored position;

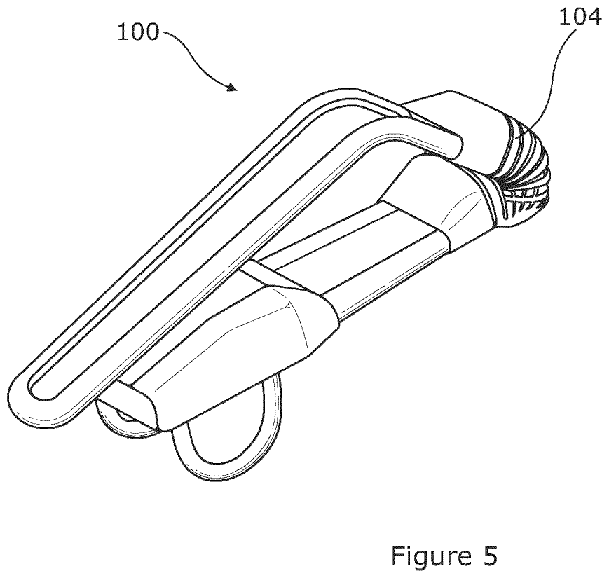

FIG. 5 shows a second example of the device, in the stored position;

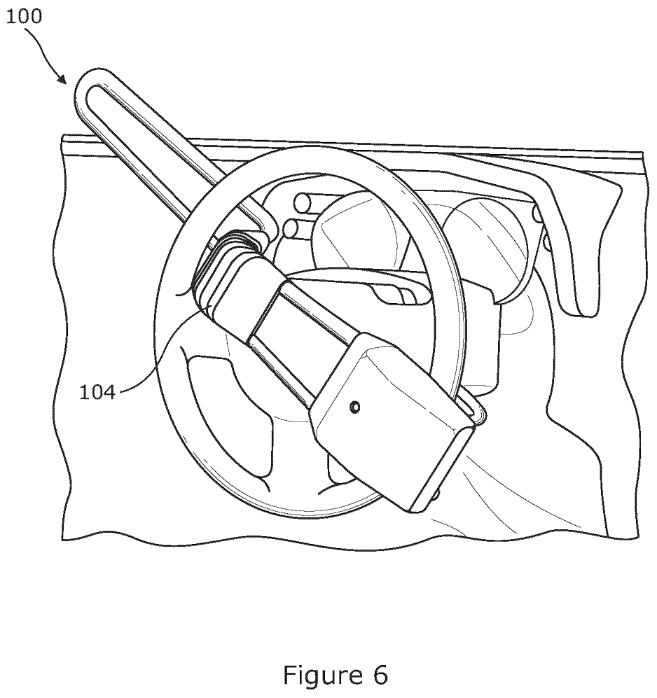

FIG. 6 shows the second example of the device, locked to a steering wheel;

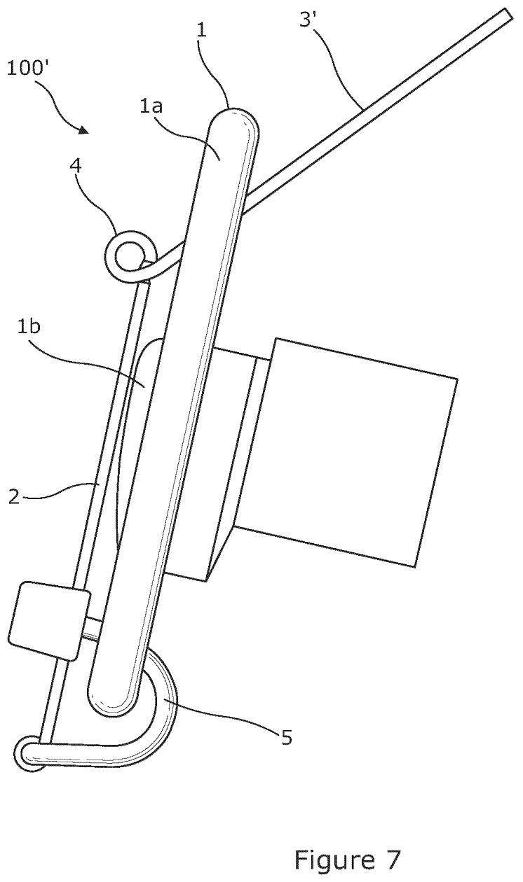

FIG. 7 shows a third example of the device with straight bars; and

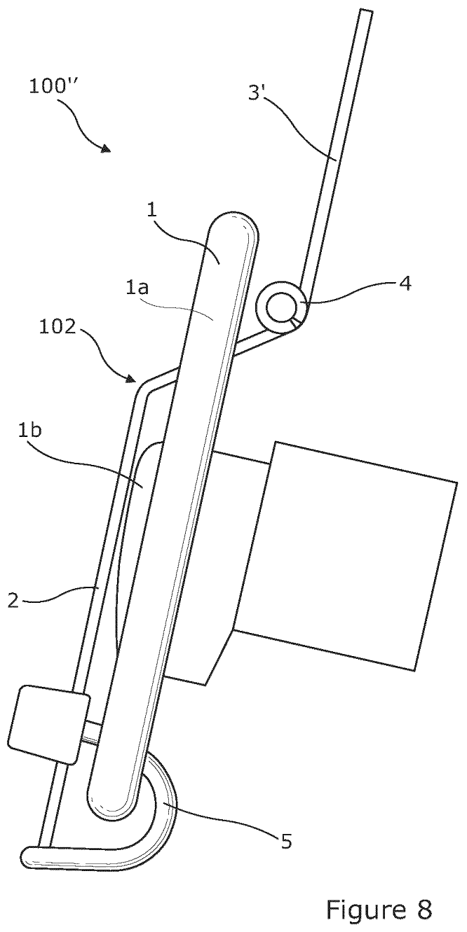

FIG. 8 shows a fourth example of the device.

FIG. 1 shows a steering wheel 1 with the device 100 lockably attached. The device 100 comprises a fixed bar 2 attached at one end by means of a hinge 4 to a folding bar 3. The other end of the fixed bar 2 is locked around the rim la of the steering wheel 1 by means of a shackle 5 pivotably mounted at one end to the fixed bar 2 by means of pivot 6. The shackle 5 is free to rotate around pivot 6 to allow the device 100 to be moved from the steering wheel except when the other end of the shackle 5 is locked into the lock housing 7.

In the preferred embodiment the lock contained within the lock housing 7 is operated with a key as in the prior art. In an alternative embodiment the lock may be operated remotely using a smartphone or remote control that operates a servo assisted lock inside the lock housing. The servo may be powered either by the vehicle battery or independent batteries positioned within the device 100.

FIG. 2 shows an elevation view of the device 100 locked to the steering wheel. In this view it can be seen how the folded bar passes through the wheel between the hub 1b and the rim 1a. It can also be seen how the shackle 5 encloses the rim la between pivot 6 and lock housing 7. The shackle 5 could alternatively enclose a spoke of the steering wheel 1.

FIG. 3 shows how the movement of the folded bar 3 in direction of arrow A is restricted by the interaction of the folded bar 3 with the rim la of the steering wheel 1 at point 8 and the interaction of the fixed bar 2 with the steering wheel at point 9. It is due to these interactions that the protruding end of the folding bar 3 remains in a position where it prevents rotation of the steering wheel due to impact with structure of the vehicle or the driver's legs. It can also be seen that rotation of the folded bar 3 in direction of arrow C is restricted at the hinge 4 by the abutment of the fixed bar 2 with folded bar 3 at point 10. If it was not for the abutment at point 10 and the folded bar 3 was free to fold in the direction of arrow C without restriction, then the device 100 could be withdrawn through the steering wheel and moved to a position where the device 100 would be ineffective.

FIG. 3 also shows the rotation of shackle 5 in direction of arrow B to allow removal of the device 100 from the steering wheel in order to use the vehicle.

FIG. 4 shows the device 100 removed from the steering wheel for storage lost the vehicle is being driven. It can be seen how the folded bar 3 is now unhindered by the rim 1a of the steering wheel and can be fully rotated in the direction of the arrow A until the device 100 is in a compact form that is easy to store. It should be noted that there is no restriction from the hinge 4 in the rotation of the folded bar 3 it abuts the pivot 6 at point 11.

The folding bar 3 is curved to fit the steering wheel 1. In this example, the folding bar 3 comprises a bend 102 along its length, shaped to pass through the steering wheel 1. The bend 102 has an obtuse angle. The obtuse angle may be a value selected from the range 110 degrees to 160 degrees.

With a bend 102, the distal, protruding end of the folding bar 3 may be generally perpendicular to the windshield, to get a high degree of obstruction with the windshield and the driver's legs.

Where the bend 102 is at a discrete position along the folding bar 3, the position of the bend 102 may be closer to the hinge 4 than to the protruding end of the folding bar 3. In another embodiment, the bend 102 is a continuous bend along the whole or substantial length of the folding bar 3, rather than a bend at a discrete point. In any case, the bend 102 may have a maximum curvature or midpoint closer to the hinge 4 than to the protruding end of the folding bar 3.

The bend 102 may be positioned far enough from the hinge 4 so that when the folding bar 3 extends through the gap between the hub 1b and rim 1a of the steering wheel 1 to the rear side of the steering wheel 1, as shown in FIG. 2, the bend 102 is located at the rear side of the steering wheel 1.

When measured parallel to a steering axis with the hinge 4 at its maximum angle, the distance of the bend 102 (or its maximum curvature or midpoint) from the hinge 4 may be greater than a rim thickness of a typical steering wheel, such as a value greater than 3 centimetres.

The bend 102 may return the folding bar 3 to a parallel orientation with respect to the fixed bar 2, when the hinge 4 is at an angle corresponding to the device 100 being locked to the steering wheel 1 as shown in FIGS. 1 and 2.

In some examples, the maximum angle of the hinge 4, defined by the point 10, may correspond to the protruding end of the folding bar 3 being substantially parallel to the fixed bar 2.

In contrast to the curved folding bar 3, the fixed bar 2 may be of approximately linear form, or at least more linear than the folding bar 3. The fixed bar 2 could have some curvature to avoid interference with a bulky airbag module at the hub 1b of the steering wheel 1.

In the compact form of FIG. 4, the internal angle between the fixed and folding bars 2, 3, measured at the hinge 4, may be an acute angle. When locked to the steering wheel 1 (FIGS. 1 and 2) so that the folding bar 3 extends through the gap between the hub 1b and rim 1a of the steering wheel 1 to the rear side of the steering wheel 1, the internal angle between the fixed and folding bars 2, 3, measured at the hinge 4, may be a reflex angle.

When locked to the steering wheel 1, the shape of the device 100 may prevent the reflex angle from reaching 180 degrees without the folding bar 3 colliding with the rim 1a of the steering wheel 1. FIG. 3 shows the bend 102 colliding with the rim a.

The acute angle may have a value selected from the range 10 to 60 degrees. The reflex angle may have a value selected from the range 200 to 340 degrees, although a range 200 to 270 degrees would be more spatially efficient and materially efficient.

When the hinge 4 is at its maximum angle due to the abutment at point 10, the reflex angle may be a maximum value less than 270 degrees, such as a value selected from the range 200 degrees to 250 degrees.

The range of freedom of the hinge 4, between the acute angle and the maximum reflex angle, is the difference between the above-specified ranges.

The hinge 4 at the reflex angle and the bend at the obtuse angle collectively give the device 100 a ‘kinked’shape, as best shown in FIG. 2.

In the compact form, a total linear length of the device 100 may be from the range 50% to 85% of the maximum total linear length when the device 100 is attached to the steering wheel 1. Therefore, the device 100 is easy to store when not in use. In the compact form, the total linear length of the device 100 may be a value no greater than 50 centimetres. When secured (locked) to the steering wheel 1, the total linear length of the device 100 may be at least 60 centimetres.

The distance from the shackle 5 to the hinge 4 may be shorter than a diameter of a typical steering wheel, for example less than 40 centimetres. This ensures the hinge 4 is aligned with the space between the hub 1b and the rim 1a of the steering wheel. For the same reason, the distance may be greater than 15 centimetres. The length of the fixed bar 2 may be within the above range. One bar 2, 3 may be longer than the other. For example, the folding bar 3 may be longer than the fixed bar 3. The linear distance of the protruding end of the folding bar 3 from the hinge 4 may be greater than the linear distance of the other (distal) end of the fixed bar 2 from the hinge 4.

As the fixed and foldable parts 2, 3 are bars in this example, the device 100 is also compact in a width dimension. The maximum width may be less than 10 centimetres. The thickness less than 5 centimetres. The total depth of the device 100 depends on the angle of the bend 102.

In the compact form of FIG. 4, the folding bar 3 may contact the fixed bar 2 at two points: the hinge 4 and another location. The ‘another location’ may be the other end of the fixed bar 2 or the shackle 5.

Where a bend 102 may be provided, the folding bar 3 and fixed bar 2 in the compact form may collectively define a triangular shape. The triangular shape may define an acute angle at each end of the fixed bar 2, and an obtuse angle at bend 102.

FIGS. 5 and 6 shows a second example of the device 100. The device 100 comprises a shroud 104 covering the hinge 4. The shroud 104 may be sufficiently elastically flexible to enable the range of freedom of the hinge 4. For example, the shroud 104 can comprise a living hinge as shown. Each end of the shroud may be connected to one of the respective bars 2, 3.

Whereas the bars 2, 3 and hinge 4 may be of metal form, the shroud 104 may be of plastics form to further facilitate the flexibility of the shroud 104.

The shroud 104 protects the hinge 4 from blunt impacts and generally increases the time and noise required for a vehicle thief to expose the hinge 4.

Although not shown, a different shackle 5 could be provided from that shown. For example, the fixed bar 2 can comprise or support a pair of protrusions extending transverse to the fixed bar 2. The protrusions may have a sliding connector. A shackle may be slidably connectable to the sliding connector, to encapsulate the rim la of the steering wheel 1 between the protrusions and the shackle. For example, the sliding connector may be in the form of a hole through one of the protrusions and a latch in the other protrusion. The shackle may be slid through the hole and into engagement with the latch.

FIG. 7 shows a further example of the device 100′where a straight folding bar 3′ is used, not having a bend 102. As a result, the folding bar 3′ is nonparallel to the fixed bar 2 when in the locked state, extending in a vehicle-fore direction.

Therefore, the device 100′ of FIG. 7 may collide with a front dashboard of the vehicle when the steering wheel 1 is turned, whereas the device 100 of FIGS. 1-6 may collide with a centre console or door of the vehicle when the steering wheel 1 is turned.

FIG. 8 shows a further example of the device 100″ where the fixed bar comprises the bend 102 and passes through the steering wheel 1 between the hub 1b and rim 1a, wherein the hinge 4 is located behind the steering wheel 1.

A technical effect of the device 100, 100′ shown in FIGS. 1-8 is that the position of the shackle 5 and the threading of the folding bar 3 under the rim 1a provides a rigid foundation for supporting the obstruction which is the folding bar 3. The folding bar 3 cannot be folded down without colliding with the rim la of the steering wheel 1.

1. A steering wheel lock device comprising:
a fixed part;
a foldable part;
a hinge connecting the foldable part to the fixed part;
a shackle to secure the steering wheel lock device to a steering wheel; and
a lock enabling the shackle to be released, wherein the shackle and the hinge are located towards opposite ends of the fixed part, and wherein when the steering wheel lock device is locked to the steering wheel, a rim of the steering wheel prevents the foldable part from being rotated to a position corresponding to a compact form of the steering wheel lock device.

2. The steering wheel lock device of claim 1, wherein when the steering wheel lock device is locked to the steering wheel, the foldable part or the fixed part passes through the steering wheel between a hub and the rim of the steering wheel.

3. The steering wheel lock device of claim 1, wherein the compact form of the steering wheel lock device has a total linear length selected from the range 50% to 85% of a corresponding total linear length of the steering wheel lock device when the steering wheel lock device is locked to the steering wheel, wherein when the steering wheel lock device is locked to the steering wheel the foldable part extends away from the shackle, and wherein in the compact form of the steering wheel lock device the foldable part extends towards the shackle.

4. The steering wheel lock device of claim 1, wherein the shackle is mounted or mountable to the fixed part by a pivot or sliding connector.

5. The steering wheel lock device of claim 1, wherein the foldable part is a foldable bar.

6. The steering wheel lock device of claim 1, wherein the fixed part is a fixed bar.

7. The steering wheel lock device of claim 1, wherein the foldable part or the fixed part has a bend shaped to allow said part to pass through the steering wheel.

8. The steering wheel lock device of claim 7, wherein the bend is closer to the hinge than to a protruding end of the foldable part.

9. The steering wheel lock device of claim 1, wherein the hinge is rotatable to a reflex angle greater than 180 degrees when the steering wheel lock device is locked to the steering wheel, the reflex angle being measured between the fixed part and the foldable part at the hinge.

10. The steering wheel lock device of claim 9, wherein the hinge limits the reflex angle to a value less than 270 degrees.

11. A steering wheel lock device comprising:
a fixed part;
a foldable part;
a hinge connecting the foldable part to the fixed part;
a shackle to secure the steering wheel lock device to a steering wheel; and
a lock enabling the shackle to be released,
wherein at least one of the fixed part or the foldable part is curved to fit the steering wheel.

12. The steering wheel lock device of claim 11, wherein the hinge enables the steering wheel lock device to be folded into a compact form which has a total linear length selected from the range 50% to 85% of a corresponding total linear length of the steering wheel lock device when the steering wheel lock device is secured to the steering wheel, wherein when the steering wheel lock device is locked to the steering wheel the foldable part extends away from the shackle, and wherein in the compact form of the steering wheel lock device the foldable part extends towards the shackle.

13. The steering wheel lock device of claim 11, wherein the shackle is mounted or mountable to the fixed part by a pivot or sliding connector.

14. The steering wheel lock device of claim 11, wherein the curved at least one of the fixed part or the foldable part defines a kinked shape to allow said part to pass through the steering wheel between a hub and a rim of the steering wheel.

15. The steering wheel lock device of claim 11, wherein the hinge is rotatable to a reflex angle greater than 180 degrees when the steering wheel lock device is locked to the steering wheel, the reflex angle being measured between the fixed part and the foldable part at the hinge.

16. The steering wheel lock device of claim 1, wherein an angle of the hinge, or a shape of at least one of the fixed part and the foldable part, or a combination thereof, allows the foldable part or fixed part to pass through the steering wheel between the hub and the rim of the steering wheel while extending away from the shackle.

17. The steering wheel lock device of claim 1, wherein the hinge is rotatable to a reflex angle greater than 180 degrees when the steering wheel lock device is locked to the steering wheel, the reflex angle being measured between the fixed part and the foldable part at the hinge, wherein the foldable part or the fixed part is a straight or curved part, and wherein the reflex angle of the hinge allows said straight or curved part to pass through the steering wheel between the hub and the rim of the steering wheel while extending away from the shackle.

18. The steering wheel lock device of claim 17, wherein a shape of the steering wheel lock device prevents the reflex angle from reaching 180 degrees without the foldable part colliding with the rim of the steering wheel, when the steering wheel lock device is locked to the steering wheel.

19. A method of attaching a steering wheel lock device to a steering wheel, the steering wheel lock device comprising:
a fixed part;
a foldable part;
a hinge connecting the foldable part to the fixed part;
a shackle to secure the steering wheel lock device to the steering wheel; and
a lock enabling the shackle to be released,
wherein the shackle and the hinge are located towards opposite ends of the fixed part, and
wherein the method comprises attaching and locking the steering wheel lock device to the steering wheel with the foldable part or the fixed part passing through the steering wheel between a hub and the rim of the steering wheel while extending away from the shackle.

20. The method of claim 19, wherein an angle of the hinge, or a shape of at least one of the fixed part and the foldable part, or a combination thereof, allows the foldable part or fixed part to pass through the steering wheel between the hub and the rim of the steering wheel while extending away from the shackle.
